(19) United States
(12) Patent Application Publication
(10) Pub. No.: US 2020/0352175 A1
(43) Pub. Date: Nov. 12, 2020

(54) ANTIBACTERIAL COMPOSITION AND ANTIBACTERIAL STRUCTURE

(71) Applicant: INDUSTRIAL TECHNOLOGY RESEARCH INSTITUTE, Hsinchu (TW)

(72) Inventors: Cheng-Han HSIEH, Changhua City (TW); Kung-Hsun HUANG, Hsinchu City (TW); En-Nan LIU, Hsinchu City (TW)

(73) Assignee: INDUSTRIAL TECHNOLOGY RESEARCH INSTITUTE, Hsinchu (TW)

(21) Appl. No.: 16/868,960

(22) Filed: May 7, 2020

Related U.S. Application Data
(60) Provisional application No. 62/846,024, filed on May 10, 2019.

(30) Foreign Application Priority Data
Dec. 27, 2019 (TW) 108148056

(51) Int. Cl. A01N 65/00; A01N 55/00

(52) U.S. Cl. CPC A01N 65/00; A01N 55/00

(57) ABSTRACT

An antibacterial composition is provided. The antibacterial composition includes a lignin, a solvent, and a silane compound. The lignin is dispersed in the solvent, and the silane compound is dispersed in the solvent. The antibacterial composition further includes an alkaline compound so that the pH of the antibacterial composition is greater than 7. The weight ratio of the lignin to the solvent is between 1:5 to 1:20, and the weight ratio of the lignin to the silane compound is between 50:1 to 200:1. In addition, an antibacterial structure is also provided.

### CROSS REFERENCE TO RELATED APPLICATIONS

This application claims the benefit of U.S. Provisional Application No. 62/846,024 filed on May 10, 2019, the entirety of which is incorporated by reference herein. This application claims priority of Taiwan Patent Application No. 108148056, filed on Dec. 27, 2019, the entirety of which is incorporated by reference herein.

### TECHNICAL FIELD

The present disclosure relates to an antibacterial composition including lignin and an antibacterial structure that is made from the antibacterial composition.

### BACKGROUND

Antibacterial substances are widely used in products such as foods, containers, cosmetics, pharmaceuticals, and other daily necessities to prevent contamination or deterioration of products due to microorganisms, or to prevent infectious diseases. Antibacterial substances play a very important role in aspects of food safety, quality control, public health, and so on.

Most of the antibacterial compositions currently in use include non-natural chemical components, for example, phenolic antibacterial compositions such as isopropyl methylphenol or parabens. Although such antibacterial compositions have excellent antibacterial properties, but when they are used in food-related fields, such as packaging materials for foods, there are still risks causing harm to human health.

Although there is less concern about endangering human health with natural antibacterial substances such as natural polyphenols, they are time-sensitive antibacterial substances, and usually have problems with leaching after a period of time. For example, the antibacterial substances may leach out from the substrate where they are coated, thereby affecting the flavor and appearance of the packaged food, and reducing the antibacterial effect.

As described above, although existing antibacterial compositions have been adequate for their intended purposes, they have not been entirely satisfactory in all respects.

### SUMMARY

In accordance with some embodiments of the present disclosure, an antibacterial composition is provided. The antibacterial composition includes a lignin, a solvent, and a silane compound. The lignin is dispersed in the solvent, and the silane compound is dispersed in the solvent. The antibacterial composition further includes an alkaline compound so that the pH of the antibacterial composition is greater than 7. The weight ratio of the lignin to the solvent is between 1:5 and 1:20, and the weight ratio of the lignin to the silane compound is between 50:1 and 200:1.

In accordance with some embodiments of the present disclosure, an antibacterial structure is provided. The antibacterial structure includes a substrate, a lignin layer and a silane compound. The lignin layer is formed on the substrate. The silane compound is dispersed in the lignin layer and fixes the lignin layer on the substrate. In addition, the weight ratio of the lignin to the silane compound in the lignin layer is between 50:1 and 200:1.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 is a structural diagram of an antibacterial structure in accordance with some embodiments of the present disclosure.

### DETAILED DESCRIPTION

The antibacterial composition and antibacterial structure of the embodiments of the present disclosure are described in the following description. It should be understood that in the following detailed description, for purposes of explanation, numerous specific details and embodiments are set forth in order to provide a thorough understanding of the present disclosure. The specific elements and configurations described in the following detailed description are set forth in order to clearly describe the present disclosure. However, it will be apparent that the exemplary embodiments set forth herein are used merely for the purpose of illustration, and are not limitations to the present disclosure.

The description of the exemplary embodiments is intended to be read in connection with the accompanying drawings, which are to be considered part of the entire written description. It should be understood that the drawings are not drawn to scale. In fact, elements may be arbitrarily enlarged or reduced so that the features of the present disclosure can be clearly expressed.

It should be understood that the terms “about”, “approximately” and “substantially” typically mean +/−10% of the stated value, more typically +/−5% of the stated value, or +/−3% of the stated value, or +/−2% of the stated value, or +/−1% of the stated value, or +/−0.5% of the stated value. The stated value of the present disclosure is an approximate value. When there is no specific description, the stated value includes the meaning of “about”, “approximately” or “substantially”.

Unless defined otherwise, all terms (including technical and scientific terms) used herein have the same meaning as commonly understood by one of ordinary skill in the art to which the present disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In accordance with some embodiments of the present disclosure, the provided antibacterial composition is a specific formula including lignin, which has good antibacterial and antioxidant properties. In accordance with some embodiments of the present disclosure, the antibacterial structure formed by the antibacterial composition includes a continuous lignin layer, which has good adhesion to the substrate, and hardly leaches out when in contact with food for a long time. In addition, in accordance with some embodiments of the present disclosure, the provided antibacterial structure also has properties of high temperature resistance and low temperature resistance.

In accordance with some embodiments of the present disclosure, an antibacterial composition is provided. The antibacterial composition includes a lignin, a solvent, a silane compound, and an alkaline compound. Lignin is a natural polyphenol, which has a good antibacterial effect and can be used as the main antibacterial component. Specifically, lignin is a poorly soluble type of polyphenol, and therefore it is less likely to be leached out and infiltrate into the packaged object (such as food) and further affect the flavor and appearance of the packaged object when it is in contact with water.

In some embodiments, the lignin may include sulfonate lignin, alkali lignin, organic soluble lignin, or a combination thereof, but the present disclosure is not limited thereto. It should be understood that in accordance with the embodiments of the present disclosure, the lignin may be modified or unmodified, as long as the polyphenol structure of the lignin itself is not damaged, the antibacterial effect may be maintained.

As described above, the antibacterial composition includes the solvent, and the lignin is dispersed in the solvent. In some embodiments, the weight ratio of lignin to solvent may be between about 1:5 and about 1:20, between about 1:10 and about 1:18, or between about 1:12 and about 1:16, for example, about 1:13, 1:14, or 1:15.

In some embodiments, the solvent may include water, an alcohol having 1 to 4 carbon atoms (C1 to C4), or a combination thereof. In some embodiments, the alcohol solvent may include methanol, ethanol, isopropanol, n-butanol, or a combination thereof, but the present disclosure is not limited thereto. For example, in some embodiments, the solvent may include a combination of water, ethanol, and isopropanol, and the weight ratio of water, ethanol, and isopropanol may be between about 1:0.5:0.5 and about 1:2:2, for example, about 1:1.5:0.5. However, in some other embodiments, the solvent may include only water.

Furthermore, the antibacterial composition includes the silane compound, and the silane compound is also dispersed in the solvent. The silane compound may serve as a cross-linking agent to increase the viscosity of the mixed solution for forming the antibacterial composition. In some embodiments, the weight ratio of lignin to silane compound may be between about 50:1 and about 200:1, or between about 100:1 and about 150:1, for example, about 110:1, 120:1, 130:1, or 140:1.

It should be understood that if the weight ratio of lignin to silane compound is too low or the amount of silane compound is too high (for example, the weight ratio of lignin to silane compound is less than 50:1), the mixed solution of the antibacterial composition may be gelled, which may be disadvantageous to the subsequent formation of the antibacterial structure, e.g., disadvantageous to coating or spraying of antibacterial compositions. On the other hand, if the weight ratio of lignin to silane compound is too large or the amount of silane compound is too low (for example, the weight ratio of lignin to silane compound is greater than 200:1), the cross-linking effect of the silane compound may be poor, and the antibacterial composition may not be fixed on the substrate.

In some embodiments, the silane compound may include an alkoxysilane having an alkoxy group of 1 to 10 carbon atoms (C1 to C10). For example, in some embodiments, the alkoxysilane may include dimethylpolysiloxane (DM'S), tetraethoxysilane (TEOS), tetramethoxysilane, N-octyltriethoxysilane, or a combination thereof, but the present disclosure is not limited thereto.

In addition, the antibacterial composition includes the alkaline compound so that the pH of the antibacterial composition is greater than 7, i.e. the antibacterial composition is in an alkaline state. In this way, the insoluble lignin can be dissolved in the mixed solution of the antibacterial composition. In some embodiments, the pH of the antibacterial composition may be between about 8 and about 12, for example, about pH 9, pH 10, or pH 11.

In some embodiments, the weight ratio of lignin to alkaline compound may be between about 1:5 and about 120:1, between about 1:1 and about 120:1, between about 10:1 and about 120:1, between about 50:1 and about 120:1, or between about 80:1 and about 110:1, for example, about 90:1 or 100:1.

It should be understood that if the weight ratio of lignin to alkaline compound is too large or the amount of alkaline compound is too low (for example, the weight ratio of lignin to alkaline compound is greater than 120:1), the lignin may not be able to effectively dissolve in the mixed solution of the antibacterial composition, which is disadvantageous to the subsequent formation of the antibacterial structure. On the other hand, if the weight ratio of lignin to alkaline compound is too low or the amount of alkaline compound is too high (for example, the weight ratio of lignin to alkaline compound is less than 1:5), an excess of alkaline compound may remain in the antibacterial structure that is finally formed (the cured antibacterial composition), which in turn may lead to the leaching of lignin.

In some embodiments, the alkaline compound may include sodium hydroxide, potassium hydroxide, calcium hydroxide, magnesium hydroxide, sodium bicarbonate, sodium carbonate, potassium bicarbonate, potassium carbonate, calcium carbonate, magnesium carbonate, ammonia water, or a combination thereof, but the present disclosure is not limited thereto. In an embodiment, since ammonia water is in a liquid state, the ammonia concentration generally is in a range from about 5% to about 30%. Therefore, the added amount will be more than other solid alkaline compounds.

In addition, in accordance with some embodiments, the antibacterial composition may further include a leveling agent, and the leveling agent may assist in the subsequent formation of an antibacterial structure. Specifically, the leveling agent may improve the quality of coating and film formation of the antibacterial composition. In some embodiments, the weight ratio of lignin to leveling agent may be between about 2:1 and about 1:15, or between about 1:1 and about 1:5, for example, about 1:1, 1:2, 1:3, 1:4 or 1:5.

It should be understood that if the weight ratio of lignin to leveling agent is too high or the amount of leveling agent is too small (for example, the weight ratio of lignin to leveling agent is greater than 2:1), then the mixed solution of the antibacterial composition may be unfavorable for coating and may shrink excessively and peel off from the substrate after curing. On the other hand, if the weight ratio of lignin to leveling agent is too low or the amount of leveling agent is too large (for example, the weight ratio of lignin to leveling agent is less than 1:15), it may result in the lignin becoming precipitated and not dissolved effectively in the mixed solution of the antibacterial composition, which is disadvantageous to the subsequent formation of the antibacterial structure.

In some embodiments, the leveling agent may include isopropyl alcohol, polyacrylate, modified cellulose, organosilicon, or a combination thereof. In some embodiments, the modified cellulose may include butyl cellulose, carboxymethyl cellulose, or a combination thereof, but the present disclosure is not limited thereto. In some embodiments, the organosilicon may include polydimethylsiloxane (silicone oil), polyether-modified polydimethylsiloxane, acrylate-polydimethylsiloxane copolymer, or a combination thereof, but the present disclosure is not limited thereto.

As described above, in accordance with some embodiments of the present disclosure, the antibacterial composition includes a specific formula, so that the poorly soluble lignin can be dissolved in the mixed solution of the antibacterial composition. The antibacterial composition can be coated or sprayed on the substrate without forming gels, and the lignin can be converted back to poor soluble after curing, which can simplify the subsequent process of forming the antibacterial structure and improve the yield of the process. The antibacterial structure formed by the antibacterial composition in accordance with some embodiments of the present disclosure will be described below.

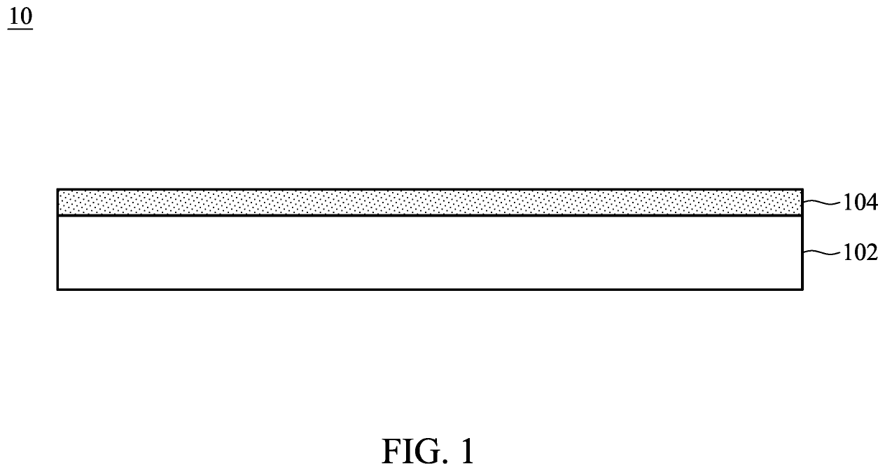

Refer to FIG. 1, which is a structural diagram of an antibacterial structure 10 in accordance with some embodiments of the present disclosure. As shown in FIG. 1, the antibacterial structure 10 includes a substrate 102 and a lignin layer 104. The lignin layer 104 is formed on the substrate 102. In some embodiments, the antibacterial composition provided in the foregoing embodiments may be formed on the substrate 102 by a coating process, a spraying process, a printing process, or other suitable processes, and the lignin layer 104 may be obtained after the antibacterial composition is cured. In some embodiments, the curing temperature may be between about 15° C. and about 100° C., or between about 25° C. and about 55° C., for example, the curing temperature may be about 25° C., 30° C., 35° C., 40° C., 45° C., 50° C. or 55° C.

The substrate 102 may be a flexible substrate or a rigid substrate. Specifically, in some embodiments, the material of the substrate 102 may include a polymer material, for example, may include polypropylene (PP), polyethylene (PE), polystyrene (PS), polyethylene terephthalate (PET), polylactic acid (PLA), polyhydroxyalkanoate (PHA), poly(butylene adipate-co-terephthalate (PBAT), polybutylene succinate (PBS), other suitable materials, or a combination thereof, but the present disclosure is not limited thereto. In some embodiments, the material of the substrate 102 may include a cardboard.

In some embodiments, the lignin layer 104 is substantially composed of a lignin, that is, the lignin is the main component of the lignin layer 104. For example, the lignin accounts for more than 95% by weight, or more than 98% by weight of the lignin layer 104, and the lignin layer 104 contains only trace amounts of other components. As described above, the lignin layer 104 may have a continuous structure. For example, the lignin does not exist in the lignin layer 104 in the form of particles or blocks in a discontinuous phase.

As mentioned above, in some embodiments, the lignin may include sulfonate lignin, alkali lignin, organic soluble lignin, or a combination thereof, but the present disclosure is not limited thereto. In addition, in some embodiments, the thickness of the lignin layer 104 may be between about 2 μm and about 15 μm, or between about 3 μm and about 10 μm, for example, about 4 μm, 5 μm, 6 μm, 7 μm, 8 μm, or 9 μm.

It should be understood that if the thickness of the lignin layer 104 is too small, the antibacterial effect of the antibacterial structure 10 may be reduced. On the other hand, if the thickness of the lignin layer 104 is too great, the adhesion of the lignin layer 104 on the substrate 102 may be reduced.

In addition, the antibacterial structure 10 includes a silane compound (not illustrated). The silane compound may be dispersed in the lignin layer 104, and fix the lignin layer 104 on the substrate 102. Specifically, after the antibacterial composition is cured, the silane compound that serves as the cross-linking agent may still exist in the lignin layer 104. The silane compound may generate bonding to the substrate 102 or may be connected to the substrate 102 by hydrogen bond so that the lignin layer 104 may be fixed on the substrate 102. Furthermore, the silane compound may exist in the lignin layer 104 in a discontinuous phase.

In some embodiments, the weight ratio of lignin to silane compound in the lignin layer 104 may be between about 50:1 and about 200:1, or between about 100:1 and about 150:1, for example, about 110:1, 120:1, 130:1, or 140:1.

As described above, in some embodiments, the silane compound may include an alkoxysilane having an alkoxy group of 1 to 10 carbon atoms (C1 to C10). For example, in some embodiments, the alkoxysilane may include dimethylpolysiloxane, tetraethoxysilane, tetramethoxysilane, N-octyltriethoxysilane, or a combination thereof, but the present disclosure is not limited thereto.

In addition, in accordance with some embodiments, the antibacterial structure 10 may further include an alkaline compound (not illustrated), and the alkaline compound may be dispersed in the lignin layer 104. Specifically, in some embodiments, after the antibacterial composition is cured, the alkaline compound may exist in the lignin layer 104 in small amounts. However, if the alkaline compound used in the antibacterial composition is ammonia water, substantially all of it is evaporated and gasified after curing. In some embodiments, the alkaline compound may be present in the lignin layer 104 in a discontinuous phase.

In some embodiments, the weight ratio of lignin to alkaline compound in the lignin layer 104 may be between about 10:1 and about 120:1, between about 50:1 and about 120:1, or between about 80:1 and about 110:1, for example, about 90:1 or 100:1.

In some embodiments, the alkaline compound may include sodium hydroxide, potassium hydroxide, calcium hydroxide, magnesium hydroxide, sodium bicarbonate, sodium carbonate, potassium bicarbonate, potassium carbonate, calcium carbonate, magnesium carbonate, or a combination thereof, but the present disclosure is not limited thereto.

As described above, in accordance with some embodiments of the present disclosure, the antibacterial structure 10 includes the continuous lignin layer 104 that is formed of the cured antibacterial composition, and the continuous lignin layer 104 has good adhesion to the substrate 102. In addition, due to the poor solubility of the lignin, after the lignin layer 104 is in contact with the packaged object (such as food) for a long time, there is still no problem of lignin leaching, which may affect the quality and appearance of the packaged object, and the lignin layer 104 can achieve the antibacterial effect for a long time. In addition, since lignin is a natural substance, the risk of impact on human health is also low. In accordance with some embodiments of the present disclosure, the provided antibacterial composition and antibacterial structure have long-lasting antibacterial properties, and are suitable for antibacterial packaging of food or other medical supplies.

A detailed description is given in the following particular Examples, Comparative Examples, Preparation Examples, and Test Examples in order to provide a thorough understanding of the above and other objects, features and advantages of the present disclosure. However, the scope of the present disclosure is not intended to be limited to these particular Examples, Comparative Examples, Preparation Examples, and Test Examples.

### Examples 1-4/Comparative Examples 1-2: Preparation of Antibacterial Composition

Examples 1 to 4 and Comparative Examples 1 to 2 were prepared according to the contents shown in Table 1. Specifically, the lignin, the solvent, the leveling agent, the alkaline compound, and the silane compound were mixed uniformly, and then the mixed solution was coated on the substrate and allowed to cure.

TABLE 1

| | | | | leveling | alkaline | silane |
|---|---|---|---|---|---|---|
| | lignin | substrate | solvent | agent | compound | compound |
| Example 1 | alkali | polyethylene | water | isopropanol | ammonia | tetraethoxysilane |
| | lignin | terephthalate | | 50 wt % | water | 0.025 wt % |
| Example 2 | 5 wt % | (PET) | | | (content: | tetraethoxysilane |
| | | | | | 25%-28%) | 0.1 wt % |
| Comparative | | | | | 10 wt % | — |
| Example 1 | | | | | | |
| Example 3 | | | water/ethanol/ | isopropanol | sodium | tetraethoxysilane |
| | | | isopropanol | 17 wt % | hydroxide | 0.025 wt % |
| Example 4 | | | (weight ratio = | | 0.05 wt % | tetraethoxysilane |
| | | | 1:1.5:0.5) | | | 0.1 wt % |
| Comparative | | | water | isopropanol | | — |
| Example 2 | | | | 50 wt % | | |

Note:
the weight percentage (wt %) of the solvent is (100 − lignin − leveling agent − alkaline compound − silane compound) *100%; the alkali lignin used in Examples 1 to 4 was purchased from Stora Enso supplier.

### Examples 5 to 6: Preparation of Antibacterial Composition

Examples 5 to 6 were prepared according to the contents shown in Table 2. Specifically, the lignin, the solvent, the leveling agent, the alkaline compound, and the silane compound were mixed uniformly, and then the mixed solution was coated on the substrate and allowed to cure.

TABLE 2

| | | | | leveling | alkaline | silane |
|---|---|---|---|---|---|---|
| | lignin | substrate | solvent | agent | compound | compound |
| Example 5 | alkali | polyethylene | water/ethanol/ | isopropanol | sodium | tetraethoxysilane |
| | lignin | terephthalate | isopropanol | 17 wt % | hydroxide | 0.025 wt% |
| | 5 wt % | (PET) | (weight ratio = | | 0.05 wt % | |
| Example 6 | organic | | 1:1.5:0.5) | | | |
| | soluble | | | | | |
| | lignin | | | | | |
| | 5 wt % | | | | | |

Note:
the weight percentage (wt %) of the solvent is (100 − lignin − leveling agent − alkaline compound − silane compound) *100%; the alkali lignin used in Example 5 was purchased from Stora Enso supplier.

### Examples 7 to 12: Preparation of Antibacterial Composition

Examples 7 to 12 were prepared according to the contents shown in Table 3. Specifically, the lignin, the solvent, the leveling agent, the alkaline compound, and the silane compound were mixed uniformly, and then the mixed solution was coated on the substrate and allowed to cure.

TABLE 3

| | | | | leveling | alkaline | silane |
|---|---|---|---|---|---|---|
| | lignin | substrate | solvent | agent | compound | compound |
| Example 7 | alkali | PP | water/ethanol/ | isopropanol | sodium | tetraethoxysilane |
| Example 8 | lignin | PE | isopropanol | 17 wt % | hydroxide | 0.025 wt % |
| Example 9 | 5 wt % | PS | (weight ratio = | | 0.05 wt % | |
| Example 10 | | PLA | 1:1.5:0.5) | | | |
| Example 11 | | PHA | | | | |
| Example 12 | | cardboard | | | | |

Note:
the weight percentage (wt % of the solvent is (100 − lignin − leveling agent − alkaline compound − silane compound) *100%; PP represents polypropylene, PE represents polyethylene, and PS represents polystyrene, PLA represents polylactic acid, and PHA represents polyhydroxyalkanoate; the lignin used in Examples 7 to 12 was purchased from Stora Enso supplier.

### Test Example 1: Adhesion Test

Adhesion tests were performed on the antibacterial structures prepared in Examples 1 to 12 and Comparative Examples 1 to 2. The adhesive tape (purchased from 3M Scotch 600) was adhered to the surface of the antibacterial structure (the lignin layer), and after 30 seconds, it was quickly removed in a direction perpendicular to the surface of the substrate. In Examples 1 to 8 and 10 to 11 and Comparative Examples 1 to 2 in which the substrate was in the form of a plate, the adhesion of the antibacterial structure was further tested by Cross-Cut Adhesion Test. The test results were shown in Table 4.

TABLE 4

| | Whether the lignin layer is peeled off from the substrate |
|---|---|
| Example 1 | No, and passed Class 5B of the Cross-Cut Adhesion Test |
| Example 2 | No, and passed Class 5B of the Cross-Cut Adhesion Test |
| Example 3 | No, and passed Class 5B of the Cross-Cut Adhesion Test |
| Example 4 | No, and passed Class 5B of the Cross-Cut Adhesion Test |
| Example 5 | No, and passed Class 5B of the Cross-Cut Adhesion Test |
| Example 6 | No, and passed Class 5B of the Cross-Cut Adhesion Test |
| Example 7 | No, and passed Class 5B of the Cross-Cut Adhesion Test |
| Example 8 | No, and passed Class 5B of the Cross-Cut Adhesion Test |
| Example 9 | No |
| Example 10 | No, and passed Class 5B of the Cross-Cut Adhesion Test |
| Example 11 | No, and passed Class 5B of the Cross-Cut Adhesion Test |
| Example 12 | No |
| Comparative | Yes |
| Example 1 | |
| Comparative | Yes |
| Example 2 | |

According to the results in Table 4, it is shown that in the antibacterial structures prepared in Examples 1 to 12, the lignin layer is not easy to peel off or fall off from the substrate, and the antibacterial structures prepared in Examples 1 to 12 all have good adhesion properties.

### Test Example 2: Lignin Leaching Test

The lignin leaching test was performed on the antibacterial structures prepared in Example 3 and Example 4. The antibacterial structures prepared in Example 3 and Example 4 were immersed in 10% of ethanol aqueous solutions (food simulation solution) at 40° C. for 10 days. The ethanol aqueous solutions where the antibacterial structures immersed were then analyzed by gas chromatography-mass spectrometry.

The results showed that after the antibacterial structures prepared in Example 3 and Example 4 were immersed for 10 days, the ethanol aqueous solutions were still colorless in appearance and no precipitate was generated. In addition, analysis results of gas chromatography-mass spectrometry showed that no lignin leaching.

### Test Example 3: Potassium Permanganate Consumption Test

A potassium permanganate (KMnO₄) consumption test was performed on the antibacterial structures prepared in Example 3 and Example 7. The potassium permanganate consumption test is one of the sanitary standard inspection items for food container packaging, and is used to detect the content of organic substance leaching. A higher consumption of potassium permanganate represents a higher content of organic substances in the leaching solution. The testing processes were carried out in accordance with the standard inspection procedures for food appliances, containers, and packaging-plastics. The test results were shown in Table 5.

TABLE 5

| | | | consumption |
|---|---|---|---|
| | | KMnO₄ titer | of KMnO₄ |
| Example 3 | Test group | 2.7 ml | 6.34 ppm |
| | Control group | 0.75 ml | |
| Example 7 | Test group | 1.25 ml | 1.62 ppm |
| | Control group | 0.75 ml | |

According to the results in Table 5, it is shown that the potassium permanganate consumption of the antibacterial structures prepared in Example 3 and Example 7 both were far lower than the upper limit of the regulatory standard, 10 ppm. It can be seen that the antibacterial structures prepared in Example 3 and Example 7 comply with sanitary and safety standards.

### Test Example 4: Antibacterial Effect Test

The antibacterial effect test was performed on the antibacterial structures prepared in Example 3 and Example 6. The meats were placed on the antibacterial structures prepared in Example 3 and Example 6, and were packaged using the modified atmosphere technology (100% of nitrogen). The packaged meats were placed on the open shelves, and the storage temperature was 5° C. After a few days, the total plate count and E. coli of the meats were measured to detect the antibacterial effect of the antibacterial structures.

The detection method of total plate count (TPC) was as follows: 10 g of the minced sample and 90 ml of sterilized water were taken, and mixed using a sample processor (stomacher, Model 400, England) for 2 minutes, and then diluted by an appropriate fold. The plate count agar (Difco) was used as the culture medium, and the sample was incubated for 48±2 hours in the incubator at 37° C., and the number of colonies was counted using a microbial counter (FDA, 1992).

The detection method of coliform group was as follows: 10 g of the minced sample and 90 ml of sterilized water were taken, and mixed using a sample processor (stomacher, Model 400, England) for 2 minutes, and then diluted by an appropriate fold. The Chromocult® coliform agar (Merck) was used as the culture medium, and the sample was incubated for 24±2 hours in the incubator at 37° C. The Chromocult® coliform agar contains two chromogens, one of which (Salmon™-GAL or Red-Gal®) can be hydrolyzed by β-D-galactosidase to show red color, and the other is X-gluc, which can be hydrolyzed by β-glucuronidase to show blue color. Since the coliform group except E. coli has β-D-galactosidase, the colonies will show red color. E. coli has both β-D-galactosidase and β-glucuronidase, which will break down both chromogens during culture, and therefore will generate colonies of dark blue color to blue-violet color. The number of colonies of red color and dark blue to dark purple color was counted using a microbial counter (FDA, 1992). The test results were shown in Table 6.

TABLE 6

| | total plate count | | count of E. coli | | |
|---|---|---|---|---|---|
| | (spoilage, CFU/g) | | (pathogenicity, CFU/g) | | odor |
| | | difference | | difference | gener- |
| | | from blank | | from blank | ation |
| | day 12 | group | day 12 | group | time |
| blank | 1.7E+06 | — | 1.3E+05 | — | day 4 |
| group | | | | | |
| Example 3 | 3.5E+05 | reduced 80% | 3.0E+04 | reduced 77% | day 8 |
| Example 6 | 1.2E+06 | reduced 30% | 8.7E+04 | reduced 33% | day 6 |

Note:
The total plate count is used to evaluate the spoiled degree of meat, the count of E. coli is used to evaluate the pathogenicity of meat; pork is used for meat.

According to the results in Table 6, it is shown that the antibacterial structures prepared in Example 3 and Example 6 can effectively reduce the oxidative spoilage of meat and inhibit the proliferation of E. coli, and has good antibacterial ability.

To summarize the above, in accordance with some embodiments of the present disclosure, the antibacterial composition of the specific formula makes the insoluble lignin dissolve in the mixed solution of the antibacterial composition, and therefore can simplify the process of forming the antibacterial structure and improve the yield of the process.

In addition, in accordance with some embodiments of the present disclosure, the antibacterial structure includes the continuous lignin layer, which has good adhesion to the substrate. The lignin layer is not easy to leach out after being in contact with the food for a long time and affect the quality and appearance of foods, therefore the lignin layer can have long-lasting antibacterial effects. Moreover, since lignin is a natural substance, the risk of affecting human health is also low. The antibacterial structures provided in some embodiments of the present disclosure have been confirmed to comply with sanitary and safety standards.

Although some embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. In addition, each claim constitutes an individual embodiment, and the claimed scope of the present disclosure also includes the combinations of the claims and embodiments. The scope of protection of present disclosure is subject to the definition of the scope of the appended claims.

What is claimed is:

1. An antibacterial composition, comprising:
a lignin;
a solvent, wherein the lignin is dispersed in the solvent;
a silane compound dispersed in the solvent; and
an alkaline compound, so that the pH of the antibacterial composition is greater than 7;
wherein the weight ratio of the lignin to the solvent is between 1:5 and 1:20, and the weight ratio of the lignin to the silane compound is between 50:1 and 200:1.

2. The antibacterial composition as claimed in claim 1, wherein the lignin comprises sulfonate lignin, alkali lignin, organic soluble lignin, or a combination thereof.

3. The antibacterial composition as claimed in claim 1, wherein the solvent comprises water, an alcohol having 1 to 4 carbon atoms (C1 to C4), or a combination thereof.

4. The antibacterial composition as claimed in claim 1, wherein the silane compound comprises an alkoxysilane having an alkoxy group of 1 to 10 carbon atoms (C1 to C10).

5. The antibacterial composition as claimed in claim 4, wherein the alkoxysilane comprises dimethylpolysiloxane, tetraethoxysilane, tetramethoxysilane, N-octyltriethoxysilane, or a combination thereof.

6. The antibacterial composition as claimed in claim 1, further comprising a leveling agent, wherein the weight ratio of the lignin to the leveling agent is between 2:1 and 1:15.

7. The antibacterial composition as claimed in claim 6, wherein the leveling agent comprises isopropyl alcohol, polyacrylate, modified cellulose, organosilicon, or a combination thereof.

8. The antibacterial composition as claimed in claim 1, wherein the pH of the antibacterial composition is between 8 and 12.

9. The antibacterial composition as claimed in claim 1, wherein the alkaline compound comprises sodium hydroxide, potassium hydroxide, calcium hydroxide, magnesium hydroxide, sodium bicarbonate, sodium carbonate, potassium bicarbonate, potassium carbonate, calcium carbonate, magnesium carbonate, ammonia water, or a combination thereof.

10. The antibacterial composition as claimed in claim 1, wherein the weight ratio of the lignin to the alkaline compound is between 1:5 and 120:1.

11. An antibacterial structure, comprising:
a substrate;
a lignin layer formed on the substrate; and
a silane compound dispersed in the lignin layer and fixing the lignin layer on the substrate;
wherein the weight ratio of lignin to the silane compound in the lignin layer is between 50:1 and 200:1.

12. The antibacterial structure as claimed in claim 11, wherein the lignin layer is composed of a lignin.

13. The antibacterial structure as claimed in claim 12, wherein the lignin comprises sulfonate lignin, alkali lignin, organic soluble lignin, or a combination thereof.

14. The antibacterial structure as claimed in claim 11, further comprising an alkaline compound dispersed in the lignin layer, wherein the weight ratio of the lignin to the alkaline compound in the lignin layer is between 10:1 and 120:1.

15. The antibacterial structure as claimed in claim 14, wherein the alkaline compound comprises sodium hydroxide, potassium hydroxide, calcium hydroxide, magnesium hydroxide, sodium bicarbonate, sodium carbonate, potassium bicarbonate, potassium carbonate, calcium carbonate, magnesium carbonate, or a combination thereof.

16. The antibacterial structure as claimed in claim 11, wherein the silane compound comprises an alkoxysilane having 1 to 10 carbon atoms (C1 to C10).

17. The antibacterial structure as claimed in claim 16, wherein the alkoxysilane comprises dimethylpolysiloxane, tetraethoxysilane, tetramethoxysilane, N-octyltriethoxysilane, or a combination thereof.

18. The antibacterial structure as claimed in claim 11, wherein the thickness of the lignin layer is between 2 μm and 15 μm.

19. The antibacterial structure as claimed in claim 11, wherein the lignin layer has a continuous structure, and the silane compound exists in the lignin layer in a
